(19) United States
(12) Patent Application Publication
(10) Pub. No.: US 2007/0046842 A1
(43) Pub. Date: Mar. 1, 2007

(54) Television having the structure adapted to flexible space layout

(75) Inventor: Chang-Cheng Lin, Taoyuan County (TW)

Correspondence Address: BIRCH STEWART KOLASCH & BIRCH, PO BOX 747, FALLS CHURCH, VA, 22040-0747, US

(73) Assignee: HANNSPREE, INC.

(21) Appl. No.: 11/294,385

(22) Filed: Dec. 6, 2005

(30) Foreign Application Priority Data
Aug. 31, 2005 (TW) 094215052

(51) Int. Cl. H04N 5/64

(52) U.S. Cl. 348/839

(57) ABSTRACT

The invention provides a TV structure which can arrange its outer components to fit the cabinets size accommodate the largest screen and maintain the best audio and visual quality and design by refitting the screen, loudspeakers, sound box and stand.

### BACKGROUND TO THE INVENTION

The invention is made to resolve problems of other systems by providing a TV structure which can be arranged with its outer components to fit existing cabinets.

### SUMMARY OF THE INVENTION

Nowadays most TVs in use are the CRT type and they are fitted with a cabinet and a bottom shelf.

Due to the progress of technology and living standards, the current trend is to buy light and flat screen LCD or PDP televisions as they are considered more fashionable.

However, the design of flat screen televisions, such as LCD, PDP and OLED do not take into account the available interior space of consumers' house; their screens are wide ones (16:9) with rectangular speakers on both sides of the 32 inch screen.

The size of old CRT screens makes them deeper and narrower, therefore the speakers are placed at the sides or below the screen and the stand is fixed at the bottom.

When we use the old type TV set, we must fit the set into the cabinet space to create a pleasing design. By rearranging the outer components of the television screen we achieve two objectives: saving interior space and creating an original design. In trying to achieve wide screens of large size, light and flat screen televisions like LCD, PDP and OLED are all designed with a wide screen in the center, speakers on the sides and a flat stand at the bottom.

In consideration of the relationship between visual effects and cabinet space, consumers are forced to dispose of the original cabinet or to fit a new one, thus wasting time and money. Also consumers may not buy new television sets because of these problems and this could adversely affect sales volumes and even halt the development of the television industry.

The purpose of this invention is to resolve the above mentioned problems and provide a TV structure with outer components that can be easily fitted to suit existing cabinets.

The new television has separable speakers and a movable stand, which can more suitably fit available space.

And the newly created TV can easily be adapted to all kinds of furniture by a simple adjustment. The speakers can be located individually anywhere and the TV set can become a console model or a hang-on the-ceiling model and the foundation stand can become a useful decoration.

These are the creative purposes of this invention

### BRIEF DESCRIPTION OF THE DRAWINGS

FIG. 1-a is a view of prior art;

FIG. 1-b shows the invention in operating conditions;

FIG. 2-a is a front view of the invention;

FIG. 2-b is a rear view of the invention;

FIG. 3-a is a front view of the invention with the front speakers below the screen;

FIG. 3-b is a rear view of the invention with the speakers below the screen;

FIG. 4-a is a front view of the invention with the speakers separated;

FIG. 4-b is a rear view of the invention with the speakers separated FIG. 5-a is a side view of the invention with the stand in a flat position;

FIG. 5-b is a side view of the invention with the stand in a folded position;

FIG. 5-c is a schematic view of the invention with the stand in a folded position;

FIG. 6-a is a top view of the stand;

FIG. 6-b is a side view of the stand;

FIG. 6-c is a front view of the stand;

FIG. 7-a is a front view of the stand in a folded position; and

FIG. 7-b is a side view of the stand in a folded position.

### DESCRIPTION OF THE PREFERRED EMBODIMENT

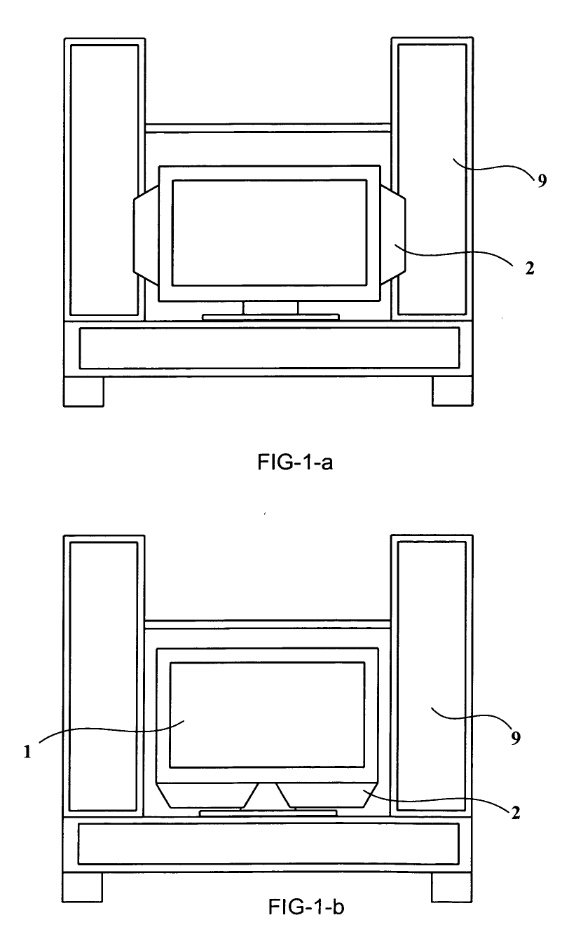

FIG. 1-a and 1-b are a comparison of this invention with the prior art.

The fitting of the speakers on the sides of a wide screen television can often be limited by the width of the furniture, such as the cabinet 9 and they cannot be assembled to fit the cabinet space (see FIG. 1-a). By addressing these problems, the invention uses the separable speaker 2 in such a way so that they can be fixed below the screen (see FIG. 1-b).

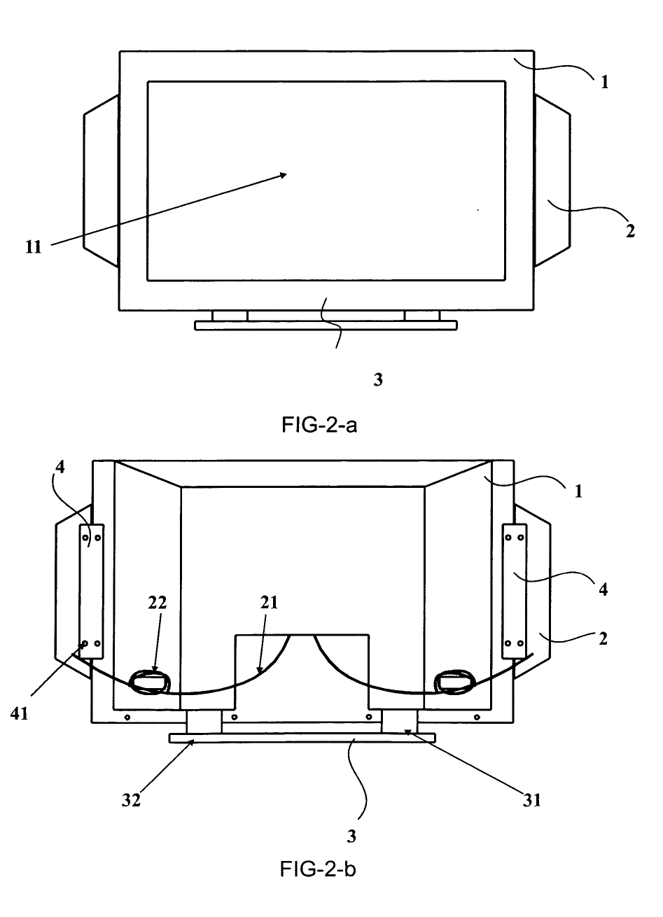

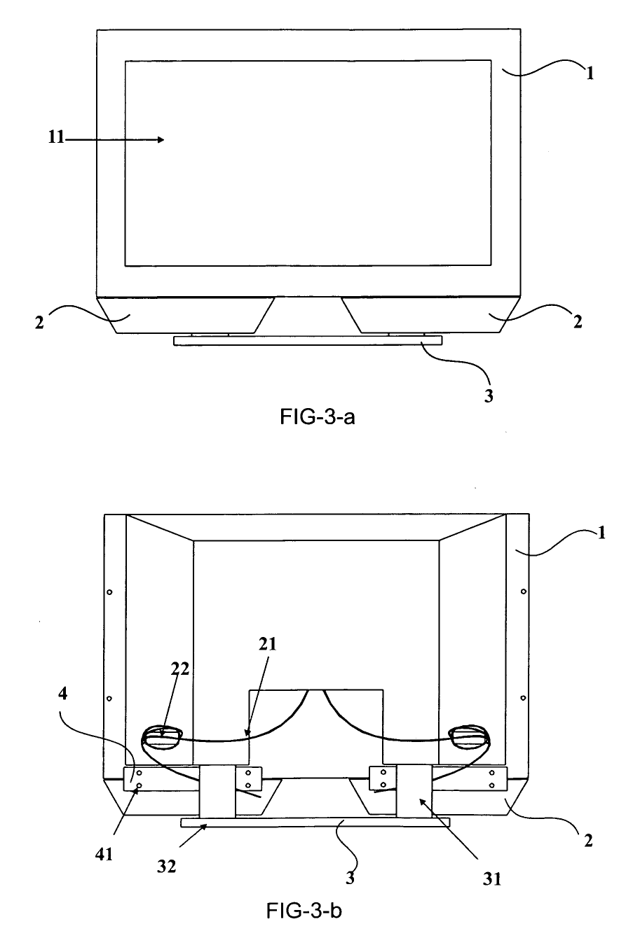

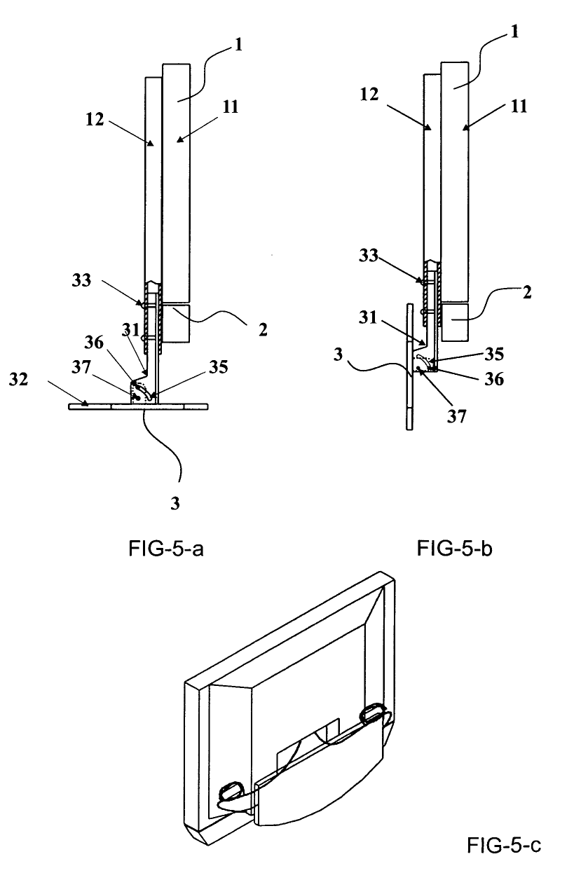

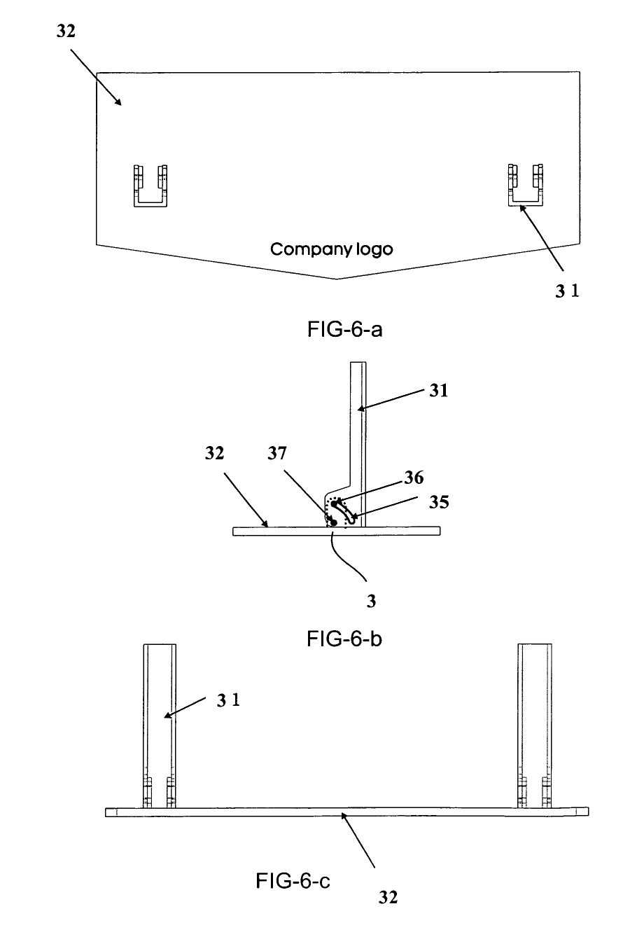

The invention provides a TV structure, which can arrange its outer components to fit any cabinet space (see FIG. 3-b) including the body 1, the separable speakers 2 and the movable stand 3. The body 1 includes the TV screen 11. Behind the body 1 is the main support tube 12 which can be fixed on the body 1 and can be adjusted in height. The separable speakers 2 can be fixed below or on both sides of the body 1 by the anchored board 4 and four anchored screws 41 (see FIG. 2-B and FIG. 3-b). The movable stand 3 includes stand holder 31, stand foundation 32 and fixed screws 33 (see FIG. 3-b and FIG. 5-a).

The stand holder 31 fixed on the main support 12 adjusts the height. The stand holder 31 is connected to the stand foundation 32 by a first pin 37 and an arc trough 35 which swivels around a second pin 36; in this way the stand is in a folded position (see FIG. 5-b).

(FIG. 2-a and 2-b) are the views of the assembly of the stand foundation 32 which allows the movable stand 3 to move up and down and fold. Through the above components, this invention which assembles the body 1, the separable speaker 2 and the movable stand 3, supports any screen size and provides the best audio and visual quality and optimum use of cabinet space.

They illustrate how the separable speaker 2 fixed on the sides of the body 1 with the anchored screw 41 and the anchored board 4, are the features of this invention.

FIG. 3-a and 3-b are the front and rear views of the assembly of the separable speaker 2, the Stand 3 and the body 1. FIG. 3-a shows the separable speaker 2 fitted below the body 1. FIG. 3-b shows how the separable speaker 2 can be fixed at the bottom of the body 1 by the anchored screw 41, through the anchored board 4.

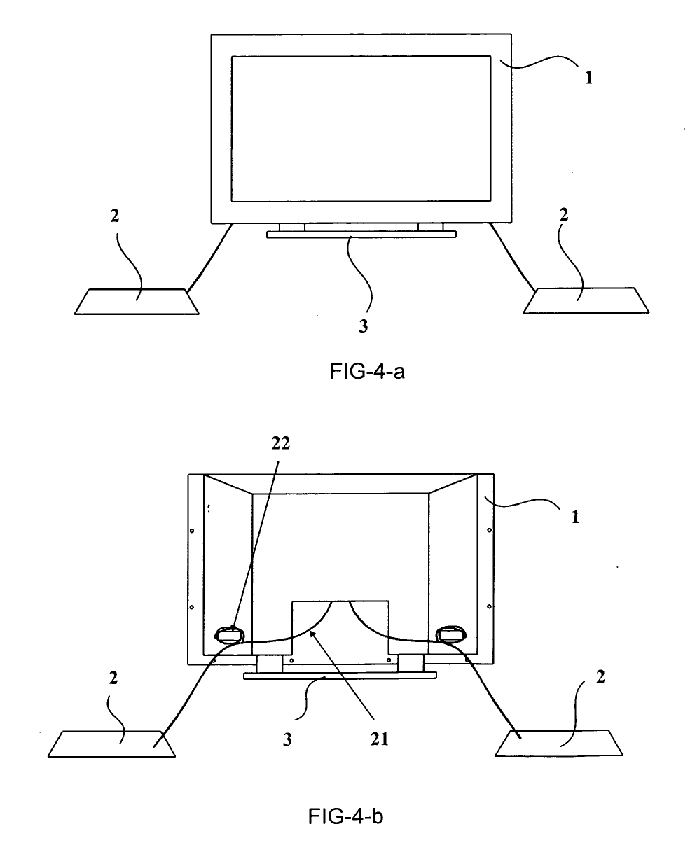

FIG. 4-a and 4-b are front and rear views of the separable speaker 2 placed at the sides and separate of the body 1. The separable speaker 2 can not only be fixed on the body 1 by the anchored board 4 and the anchored screw 41, but also placed at the sides of the TV set by extending the speakers cables (see FIG. 4-b).

Any excess cable can be collected in the recovery wire area 22 located behind the body 1. Furthermore the separable speaker 2 can combine with the body 1 by placing adhesive magnetic tape around the body 1.

FIG. 5-a and 5-b are views of the assembly of movable stand 3 and body 1. The main support tube 12 behind the body 1 can be assembled with the stand holder 31 below. The movable stand 3 includes the stand holder 31, the stand foundation 32 and the fixed screw 33. The stand holder 31, which is set in the main support tube 12, can be adjusted in height by raising or lowering it. The fixed screw 33 can be fastened at the correct height.

The stand holder 31 is pivoted with the stand foundation 32 by the fixed pin 37 and in the bottom of the arc trough 35, which connects with the pin 36 of the stand foundation 32 and the pin 36 can slide up and down to fold the stand foundation 32.

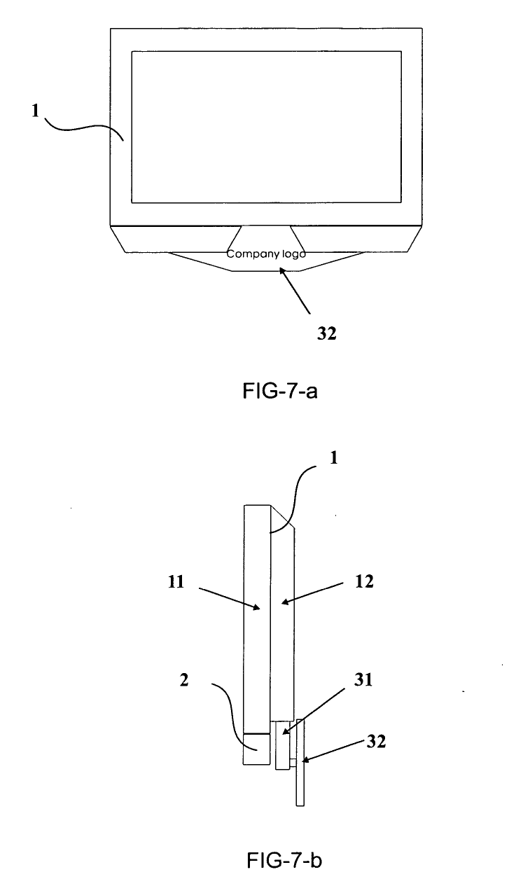

FIG. 7-a and 7-b show the stand foundation 32 which can be folded to be a frontal decorating board if the television is hung on the wall (see FIG. 5-b). Therefore it will suit different needs and tastes. The stand foundation 32 can also be made of transparent board, which has the company logo on it or on the back of the board. The logo will show between the two speakers, which could serve a commercial purpose.

This invention obviously possesses business value and could be useful in many ways and it should be taken up throughout the TV industry. The above views are part of the applied ways of this invention. The other related ways to assemble the object, separable speakers and movable stand would be regarded as the technical features of this invention.

What is claimed is:

1. A television having the structure adapted to flexible space layout comprises a body 1, plural separable speakers 2, and a moveable stand 3 where in, said body 1 including a screen 11 and a main support tube 12, said main support tube 12 deposits at the back of said body 1;
said separable speaker 2 fixed around said body 1 by a fixed board or positioned separately from said body 1;
said moveable stand 3 is made up of a stand holder 31 and a stand foundation 32, where said stand foundation 32 is fitted with said stand holder 31 and said main support tube 12 so as to obtain the function of height adjustment.

2. The television as in claim 1, wherein said main support tube 12 can be assembled with said stand holder 31 below so as to adjust the height, and said stand holder 31 pivoted with said stand foundation 32 by a first pin 37, and said holder 31 having an arc trough 35 swiveling around a second pin 36 allowing it to be folded, raised or lowered.

3. The television as in claim 1, wherein said separable speaker 2 can be placed separately, on both sides of said body 1.

4. The television as in claim 1, wherein the extending cables of the separated speakers are housed individually at the back of said body 1.

5. The television as in claim 1, wherein said separable speaker 2 can be fixedly attached to the television.

6. The television as in claim 1, wherein said stand 3 can be placed at the bottom of the television, whenever it is used as a stand and can be adjusted in height by said stand holder 31 and said main support tube 12.

7. The television as in claim 1, wherein said stand foundation 32 can be folded to become a frontal decorating board when said body 1 is hung on the wall.
